(19) United States
(12) Patent Application Publication
(10) Pub. No.: US 2009/0070832 A1
(43) Pub. Date: Mar. 12, 2009

(54) System for Presentation of Live Video and Audio Compilations on TV Using the Internet

(75) Inventor: Adam Urban, Hilversum (NL)

Correspondence Address: DAVID I. ROCHE;BAKER & MCKENZIE LLP, 130 EAST RANDOLPH DRIVE, CHICAGO, IL, 60601, US

(73) Assignee: UPLOADED, INC., Amstelveen (NL)

(21) Appl. No.: 12/298,176

(22) PCT Filed: Apr. 25, 2007
(86) PCT No.: PCT/US07/10019

§ 371 Date: Oct. 23, 2008

Related U.S. Application Data
(60) Provisional application No. 60/795,034, filed on Apr. 26, 2006.

(51) Int. Cl. H04N 7/173

(52) U.S. Cl. 725/86

(57) ABSTRACT

The system includes a network that allows a user (an uploader), who has made a compilation playable as a video or audio or both, to visit a website and make arrangements for his or her compilation to be broadcast on one or more TV channels in various locations around the world. The uploader who has created a video, for example, will visit the website and upload his or her creation to the website. After uploading, the website will present the uploader with options as to where, on what type of outlet (media devices, terrestrial TV, video on demand, satellite TV, cable TV, Internet, mobile phone or other outlet) and when (or in what time window) his or her creation will be played. The website, optionally, may charge user or not charge the user a fee. Whether or not a fee is paid, the video may be edited in order to make it comply with broadcast safety standards and/or for compliance with rules governing the outlet over which the video will be played. The creation may be accessible to users of the website before or after the creation is broadcast. Operators of outlets may be given access to uploaded content for their selection and use.

### FIELD OF INVENTION

This system described herein relates generally to the field of presenting video and audio broadcasting through an internet portal. More particularly this system is capable of providing users the ability to interact with their TV, radio or internet TV by uploading the audio or video content via the internet on to a secured web site, for subsequent transmission based on the time purchased by the user/sender.

### BACKGROUND

There is a large amount of activity in the general field of video transmissions and audio transmissions through online means. The consumers' interest in interactive audio and video transmissions of their specific choice and interest has been growing at an exponential rate. The difference between the conventional video transmissions and audio transmissions and the transmissions made available by online means has been so much pronounced that, it has attracted a highly quantified gathering. This has been due to a prominent qualitative difference in viewing experience and visual interactivity of online video services. The prior art is flooded with a large number of patented inventions and technical literature on the subject in question.

The popularity and acceptability of interactive TV made possible by online video transmissions can be gauged from the fact that by the end of year 2004 an estimated 30-70% viewing audience had shifted to interactive TV from pre-existing options. As such with an increase in number of online users it is estimated that number of consumers for interactive TV viewing would also increase in a proportionate manner. This implies that market for online video transmission would be required, as also the service providers for making available the online video transmissions.

The last decade has witnessed continued and successive development in the field aimed at providing better ways and means for delivering online video and audio transmissions as per consumers' tastes and preferences. With passage of time the focus has shifted to making efforts for integrating the numerous computerized information systems to provide an improved information delivery for entertainment systems and thus enhance the quality of viewing in interactive TV.

At present there exist several approaches for provisioning apparatus and systems and/or devices as well as methodology for presenting live video and audio transmissions on TV using internet based communication and transmitting channels.

The prior art profile indicates the existence of numerous systems and methods for presentation as well as sending of video and audio packages for broadcasting and transmission.

U.S. Pat. No. 6,904,263 issued to Grudnitski et al describes a method and system for interactive case and video-based teacher training.

U.S. Pat. No. 6,564,380 issued to Murphy discloses a system and method for sending live video on the internet. The system described herein provides for an internet based network system to control, monitor and effectively administer the commercial distribution of live video compilations obtained from the large number of video cameras installed at numerous remote locations.

U.S. Pat. No. 6,493,872 issued to Rangan et al discloses a method and apparatus for synchronous presentation of video and audio transmissions.

U.S. Pat. No. 6,803,945 issued to Needham discloses a motion detecting web camera system.

U.S. Pat. No. 6,882,793 issued to Fu et al discloses a video processing system.

U.S. Pat. No. 6,449,608 issued to Morita et al discloses a video searching method and apparatus for same.

U.S. Pat. No. 6,972,681 issued to Mutsuoka et al discloses a monitoring apparatus.

U.S. Pat. No. 6,269,394 issued to Kenner et al discloses a system and network for delivery of video data over a computer network.

U.S. Pat. No. 6,597,736 issued to Fadel discloses a throughput enhanced video communication system.

U.S. Pat. No. 5,956,716 issued to Kenner et al discloses a system and method for delivery of video data over a computer network.

Korean Patent Application KR 2002 00 50597 of Lee Jae Seong discloses a control method for home network systems.

Korean Patent Application KR 2003 00 57575 of Choi Jong Yun describes an automatic video data transmission system.

The prior art indicated above does not provide a comprehensive solution to the bulky structural designs and an does not afford simplicity in manner of operation.

Another notable drawback in the existing prior art is that it does not cater tQ the need of user specific demands for online based video transmission.

The existing prior art also suffers from the defect of not being able to address the consumers' needs in terms of interaction with TV radio or internet TV.

The prior art does not address the issues of simplicity in operation by users for directly purchasing the time slot for uploading of their videos for further transmission.

Accordingly there exists a need for providing a system for presenting live video and audio transmissions using the internet.

In view of the foregoing disadvantages inherent in the above-mentioned prior art, the general purpose of the system described herein is:

to provide an improved combination of convenience and utility,
to include all the advantages of the prior art,
to attempt to overcome the major disadvantages/drawbacks of the prior art, and

to provide a system for presenting live video and audio transmissions using the internet.

### SUMMARY

The system described herein provides an easy to use system for presenting live video and audio compilations on TV using the internet. The system makes use of the internet by providing linkup between an user(s) and a secured web site enabling the user to upload specific compilations on to the site and obtaining a time slot for airing the compilations based on the slot allotted to an user by the website.

It is an object of the system to provide an alternative choice to an user to avail transmission of specific video and audio compilations as per one's own choice criteria.

It is a further object of the system to offer secure authentication of access to an interactive TV environment.

It is another objective of the system to offer a customized and/or personalized presentation of user specific programmes on national TV.

For a better understanding of the system and its operating advantages and the specific objects attained by its user, reference should be made to the accompanying drawings and descriptive matter in which there are illustrated embodiments and examples.

### BRIEF DESCRIPTION OF DRAWINGS

For a better understanding of the nature of the system, reference should be made to the detailed description taken in conjunction with the accompanying drawings in which:

FIG. 1 is a diagrammatic depiction of the components of an exemplary system.

FIG. 2 is a diagrammatic depiction of functional details of an exemplary system.

FIG. 3 is a block depiction of the integrating components of an exemplary system.

FIG. 4 is a detailed view of the user enabled accessing device of an exemplary system.

FIG. 5 is a detailed view of the accessible web server component of an exemplary system.

FIGS. 6 and 7 are two parts of a single flow diagram, from a user's point of view, of the steps by which a user's video or audio compilation may be transmitted and/or booked for play on television outlet.

FIG. 8 is a flow diagram from website operator's point of view, of how a video or audio compilation may be received and processed for play on a television outlet.

### DETAILED DESCRIPTION

The exemplary embodiments described herein detail for illustrative purposes are subject to numerous variations. It is understood that various omissions, substitutions or equivalents are contemplated as circumstances may suggest or render expedient, but is intended to cover the application or implementation without departing from the spirit or scope of the claims.

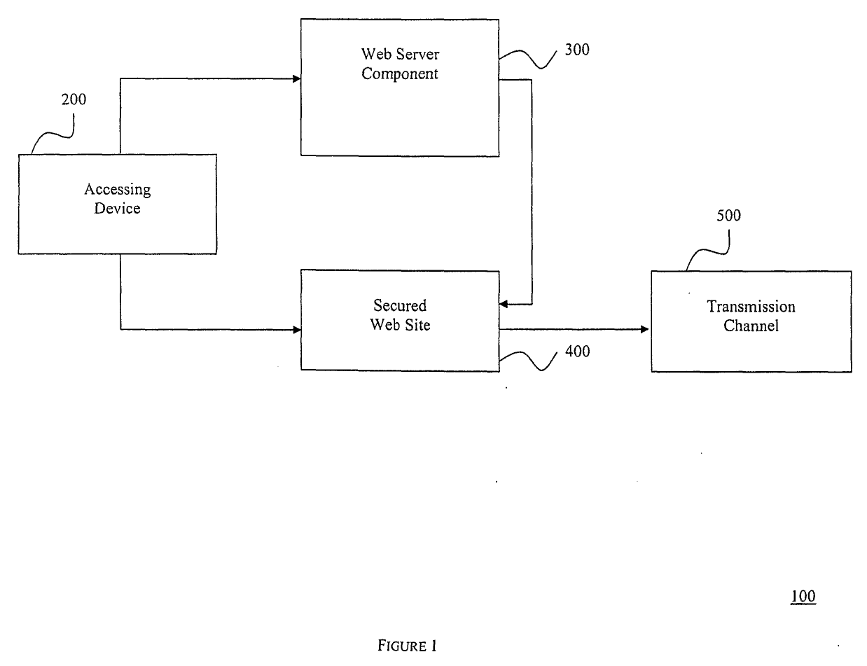

FIG. 1 is a diagrammatic depiction of the components of a system for presenting live video and audio compilations on TV using the internet, and the system is depicted as 100. The system 100 comprises of an user enabled accessing device 200, an accessible web server component 300, an accessible secured web site 400, and a transmission channel 500.

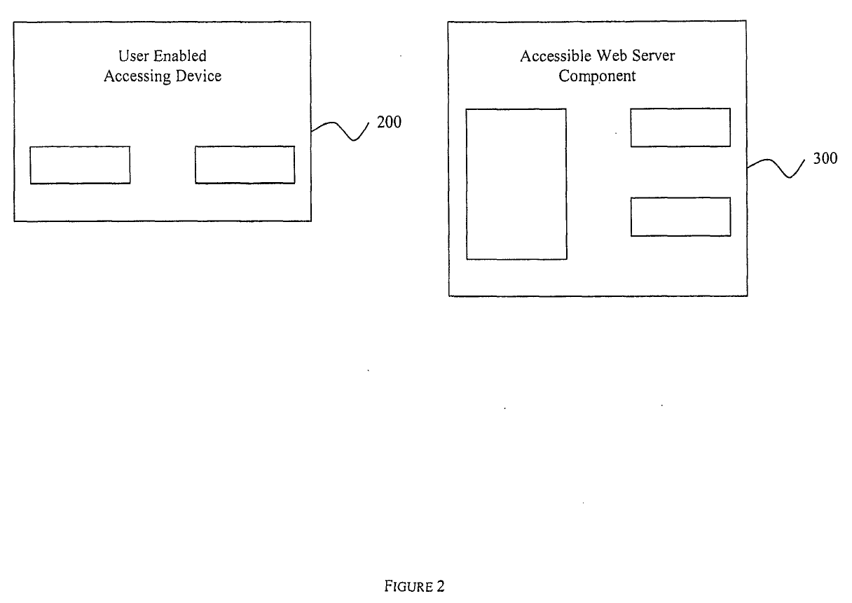

FIG. 2 is a diagrammatic depiction of functional details of the system in which are shown the further details of the various components. The user enabled accessing device 200 further comprises of a web browsing component 220 and a communicating component 240. The accessible web server component 300 further comprises of the customized web site recognizing unit 320, a sign up unit 340, and a reporting unit 360.

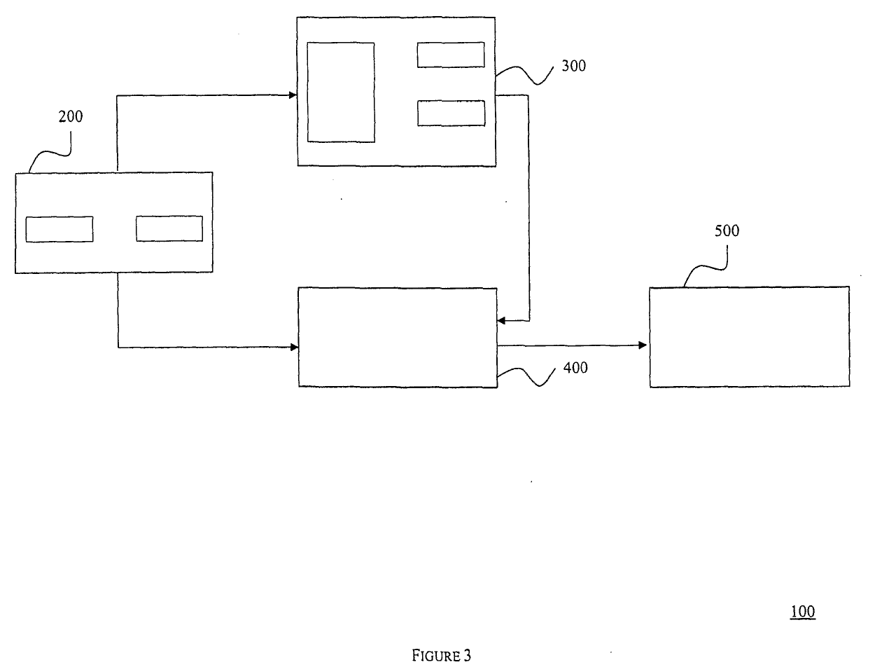

FIG. 3 is a block depiction of the integrating components of the system described herein.

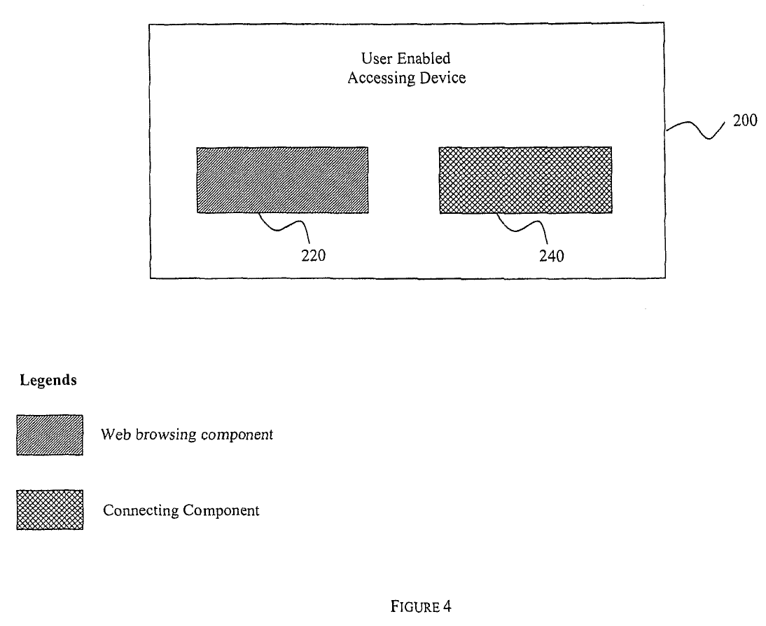

FIG. 4 is a detailed view of the user enabled accessing device in the system described herein.

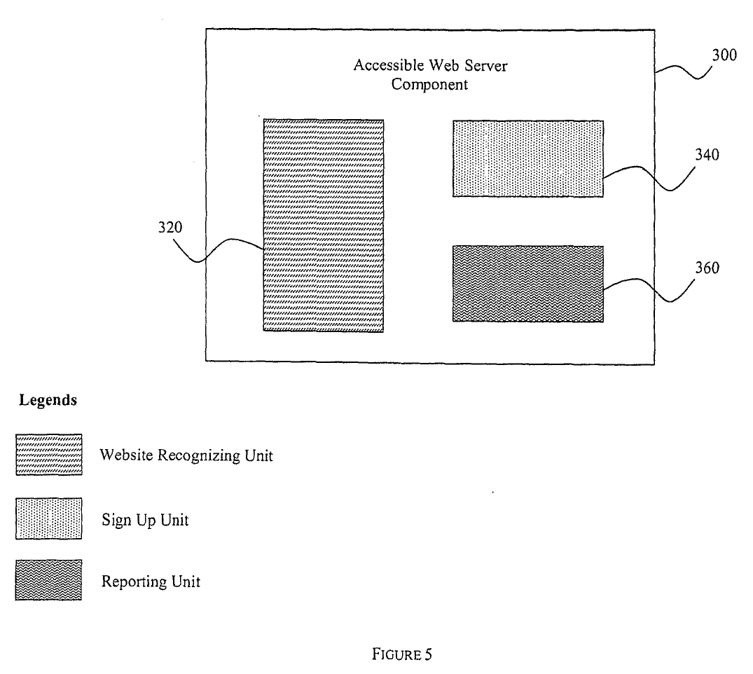

FIG. 5 is a detailed view of the accessible web server component in the system described herein.

In the preferred embodiment of invention, the best working mode of the invention entails that the user makes a video or an audio compilation and through his account with the secured web site, enters the site to upload the selected compilation. The system 100 is synchronized to function in such a manner that secured web site 400 which has to its disposal purchased air time on TV channels allots to different users the time frame for transmission of uploaded compilations as per user's choice.

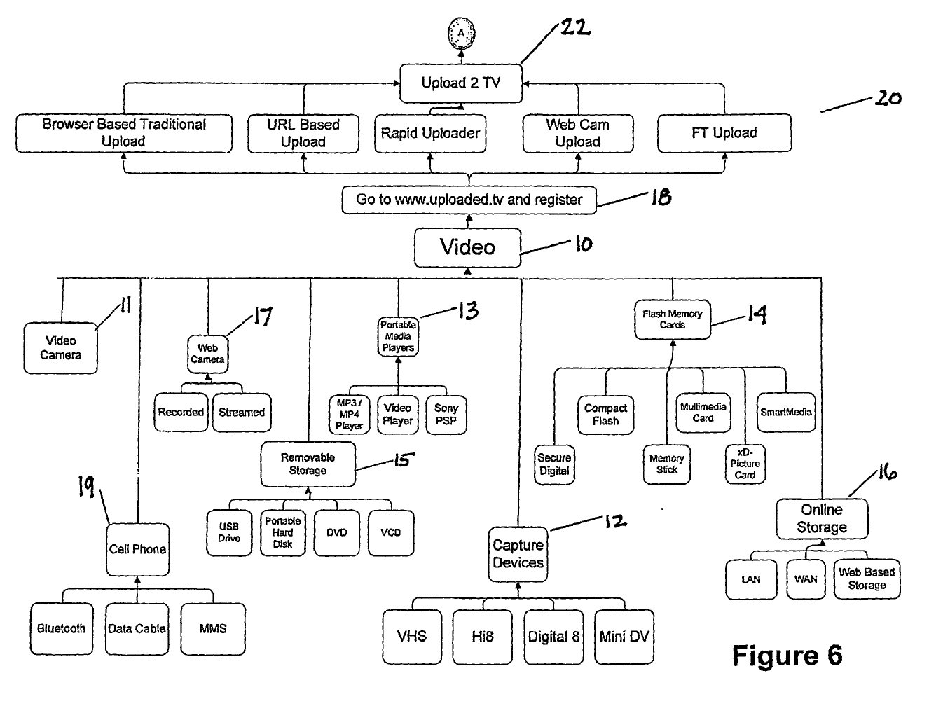

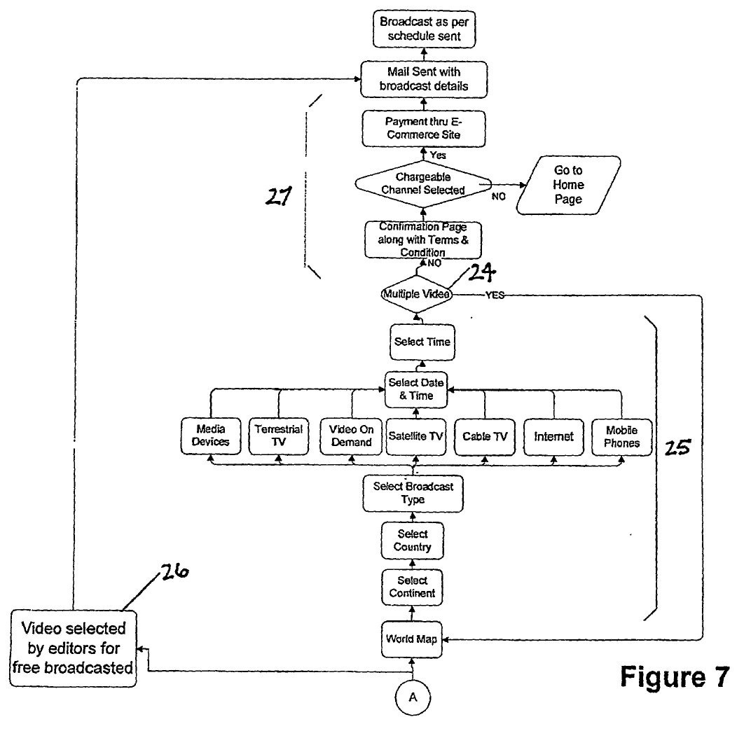

An example of a system for accomplishing the objectives stated herein is depicted in FIGS. 6 and 7, which together (connected at point “A” at the top of FIG. 6 and the bottom of FIG. 7) form a flow chart of the external (or front end) steps by which a user's video is broadcast as or as part of television program in accordance with the inventions described herein.

A user (an individual or company) creates a video 10 with a video recording device, such as a camera, cell phone, or other digital or analog device that stores moving pictures. The original video may come from a variety of sources, such as those shown in lower portion of FIG. 6. These sources include a video camera 11, a web camera 17, a cell phone 19, or VHS tape, Hi8 devices, Digital 8 and Mini DV devices, which may have to be processed by a capture device 12 for uploading to a website. Alternatively, the source of the video may be in digital form in a flash memory cards 14 (with data from secure digital devices, compact flash memory devices, memory sticks, XD picture cars, multimedia cards and smartmedia) or may have been previously stored at an online or remote storage location 16. The video should be stored in a way that allows a computer to access it. This storage may be removable storage 15 (such as hard disk drives, DVDs, VCDs and USB drives). Video may be uploaded from portable media players 13 (such as MP3 and MP4 players, video players and Sony® PSP devices), fdata sticks, hard disks CDs, DVDs etc. or a variety of other storage devices or media that a computer can access.

The user may then use a computer to access a video storage file, and move this video 10 file to the website 18 (here called “uploaded.tv”). In an uploading step 20, a user will select the video using a browse button on the website to select the video for delivery to the website's computer. Uploading step 20 can take place via FTP, rapid upload software, web cam, or browser based upload.

Selection options for uploading videos include the following methods:
URL—Upload: This takes videos already on the web using just a pre-existing Uniform Resource Locator (or URL)
Traditional Browser-Based Upload
Rapid Uploader (200% faster than traditional video sites-download)
Web Cam Upload
FTP—this allows people to upload direct to our servers (larger files)

Once the uploading step 20 is complete, the website will typically send the user a message that the step has been successful, and the website will present a link to the user that takes the user to the step of where and when have the video played on television. Once a user has a video uploaded to the website's servers and database, the user will be presented with a platform 25 with a way of selecting where and when a video will be played on television. The platform 25 may have a world map (bottom of FIG. 7), and be asked to select a continent and country where he or she would like the video played on television. After selecting a country, a list of channels by broadcast type will appear. From here a user can select one or a multiple channels from a list of all channels on which they would like to have their video appear in that country. At step 24, the user may select another video from among those that the user has uploaded. The user will have the option of selecting channels on regular airwave networks, satellite TV, cable TV, digital networks, internet broadcast channels, VOIP, IPTV, mobile, video radio, terrestrial, ipods, PDA's, MP4 players, web “television” or any device with a screen that is able to broadcast video files.

The user or uploader may select channels from a list that shows availability of dates and the form of television that the user may select for broadcasting the video. The user selects date and time from a calendar. The calendar may show both available and unavailable times. Once the video has been matched with an available time by the user, the user will be asked whether he or she wants to “book” the time slot for the video. In the “book videos” step the channel, date time and show will be shown to the uploader. The uploader may also be shown the amount of time available for that booking period. A booking period is defined by the operators of broadcasters themselves. For example, the channel may provide half hour to multiple hours of air time for which a user can select and book the time. The uploader may be able to either book an exact time that his or her video will appear on the selected channel, or may book a period of time during which the video may appear. For example from 1:00-1:30 AM. So if the clip is 30 seconds the video will appear some time within this period. Similarly, an owner of several channels may offer that the video will be shown on one of several channel within a selected period. The price will likely vary based upon how flexible the user is.

After booking the video the uploader will see a confirmation section with details such as video name, show, video duration, channel, date, time (or period or window of time) and price. The user will likely be required to accept the terms and conditions supplied by the website operator, and rules that may be imposed by the broadcaster or owner of the channel selected. If the rules are followed, the website operator may then be able to guarantee to the uploader that his or her video will appear on the channel selected at the time (or during the window of time) selected and booked. If the rules are broken, however, the video will not appear.

After terms and conditions have been selected and a video is selected, an uploader can then checkout and make payment. The website may include as part of its user interface, as payment system or subroutine 27 which will also confirm that the user has agreed to certain rules and rights on the part of the website operator (or outlet operator) to edit the user's submission. If the channel is charging a fee for the uploader's video to appear on television, the uploader will be required to pay with a credit card or through a secured ecommerce web gateway, such as Paypal®

After payment has been confirmed, the uploader will be sent a confirmation email and message with information about when the video will appear on television.

The videos may undergo an editing step 26. Some uploaders may be selected by an editor or editing staff as part of the website operation, and some videos may be selected to appear on one or more channels or broadcast media free of charge. These “freeloaders” will have no idea when they will appear on TV until we tell them.

After time slots have been booked, the videos or video data that have been selected will be sent to a storage server (either linux or windows) where the videos or video data will become part of a website's database. This database will hold the videos or video data of each channel, show, time, and date that an uploader has booked for his or her video of video data to appear on a television channel. In this way there will be a data base of all videos for a particular day, time, channel.

The videos or video data may be stored on servers until it is time for the website operator (or a third party editor or producer) to formulate a “show.” “Shows” will be edited using converted or original files that are stored on servers and indexed. Editors or computer editors will either download the video files or video data and assemble the clips into an edited show, or the files will be edited remotely by direct access to storage servers. When the website operator receives a video or video data sent to the website, the uploader will likely agree that the website operator will have the right to make derivative works in any editing process using the video or video data submitted.

The term “show” as used herein is meant to include one video or a series of videos, usually at least partially edited, that will play on a given time slot on one or more channels. The final edited show may be transmitted to the broadcast facilities in a number of ways. The final edited show may be delivered to a broadcaster or channel operator on Digi beta, CD, or DVD. The final edited show may also be sent to a broadcast or channel operating facility via a satellite. The final show may also be broadcast directly to a satellite. The final edited show may be uploaded to a windows or linux storage server of any type or configuration for download by the broadcast or channel operating facility. The final edited show may be sent to the broadcast facility through a LISP server. The final edited show may be sent digitally through an internet connection to the broadcast facility.

Final control over the broadcast of the video will likely be in the hands of the broadcast facility who receives the video and subject to their internal operations and broadcast infrastructure.

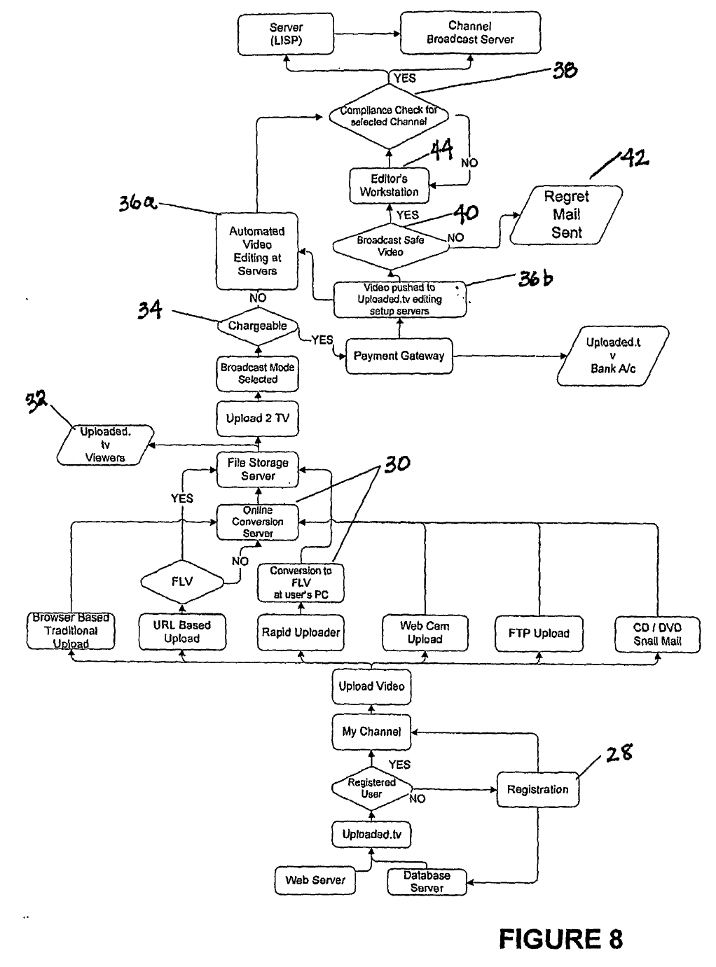

FIG. 8 shows the key internal (back end) steps by which a user's video is processed, converted, stored and broadcast (for a fee or without a fee) by a website operator. At the bottom of FIG. 8, a website in accordance with the inventions shown and described herein will check a potential uploader to determine whether the uploader is a registered user of the website. If the uploader is not registered, he or she will be required to undergo a registration step 28. Once registered, the uploader will be able to upload one or more videos or sets of video data from various sources and in a manner described above and shown in FIG. 6. The video will be converted in a conversion step 30 to FLV (Flash Video format).

After being uploaded and converted, and after the time slot or slots and channels for broadcast selected (as shown in FIGS. 6 and 7 and discussed above), the website operator will be made available to viewers of the uploaded.tv website in step 32. In addition, the website operator (or a broadcaster or channel operator) may determine in step 34 that a video has sufficient merit so as not to be chargeable (i.e., broadcast for no fee). At step 36a the “freeloader” video may be edited at editing servers. Similarly, videos for which payment has been made may then be edited at step 36b by the website operator at setup servers. After editing, at step 38 the freeloader videos are then checked for compliance with rules of the channel or channels on which they are selected for broadcast. Similarly, the videos for which time has been purchased will be checked at step 40 for whether they are broadcast safe, such as for decency and the like. If the video is not broadcast safe, a regret message (step 42) may sent to the uploader of the rejected video, and under some circumstances a full or partial refund may be given. Even if a video is deemed broadcast safe, it may still not comply with rules of the channel over which the video has been selected for broadcast. So, a video for which a fee has been paid may need to be further edited in a second editing step 44 to ensure that it complies the rules of the channel selected by the uploader. However, once the compliance check step 38 has been completed, the video will be sent to the broadcaster or channel operator's server and/or a LISP sever, and will be ready for broadcast at the selected time, times for time period on the selected channel or channels.

The terms broadcast network or outlet, as used herein, are intended to include any possible way of delivering video or audio content to the viewer or listeners (public or private), including satellite TV networks (e.g. Dish Network), regular airwave networks (ABC, CBS, NBC, FOX etc.), pay-per-view channel and other channel owners (MTV, Playboy Channel, HBO etc.), cable TV system operators (Comcast etc.), mobile telephone companies (Verizon, T-Mobile etc.), internet website operators (e.g., itunes) and broadcasters of any other type or method.

Although, a particular exemplary embodiment has been disclosed in detail for illustrative purposes, it will be recognized to those skilled in the art that numerous variations or modifications of the disclosed system, including the rearrangement in the configuration of the scheduling aspects of the system as well as its method of use being amenable to modifications on account of an individual user's/individual customer's need, are possible.

Accordingly, the invention claimed herein are intended to embrace all such alterations, modifications and variations as may fall within the spirit and scope of the following claims:

I/We claim:

1. A system for presenting video and/or audio compilations on television and/or radio channels on an outlet such as a broadcast network, said system comprising:
an accessible website for interacting with users that have created a video or audio compilation;
an web server for receiving communications from users at said website;
a platform on said website for presenting options to a user for selecting:
available times to a user at which said video specified transmission on TV/Radio;
a location or locations where the user's video and/or audio compilations may be booked for play on one or more outlets;
a storage device accessible by an operator of the website for making stored video and/or audio compilations available for later editing by a website operator and/or for transmitting said compilations to an operator of said outlet;
a portal for delivering said video and audio compilations to an operator of said outlet.

2. The system of claim 1, wherein said platform presents a user with a map of the world offering location options including continent and country.

3. The system of claim 1, wherein the said platform presents users with options regarding broadcast type or channel type.

4. The system of claim 1, wherein the website allows payment by a user for booking a broadcast time and location for the broadcast of the video and/or audio compilation.

5. The system of claim 1, wherein said server includes a conversion device for converting a video and/or audio compilation from one video and/or audio fomat in to another format.

6. The system of claim 1, wherein the said server comprises:
a customized web site recognizing unit;
a sign up unit;
and,
a reporting unit.

7. The system of claim 6, wherein the said customized web site recognizing unit is user specific, with the said specification being linked with a particular user profile and with needs and choices, specific to a particular user.

8. The system of claim 6, wherein said customized web site recognizing unit is connected and interlinked with said sign up unit, and said reporting unit.

9. The system of claim 6, wherein said customized web site unit communicates with said user.

10. The system of claim 6, wherein said sign up unit enables the user to sign up with said secured web site.

11. The system of claim 6, wherein said reporting unit is equipped to connect with said secured web site.

12. The system of claim 6, wherein the said reporting unit is responsible for recording the actions related to information accessing and information sharing between users and said website.

13. The system of claim 5, wherein said storage device is accessible by editing station that allows an operator of the website to edit the video and/or audio compilation.

14. The system of claim 13, wherein said website includes a payment gateway that allows a user to book a specific time and/or time window for broadcast of the video and/or audio compilation.

15. The system of claim 13, wherein the server allows a user to upload multiple video and/or audio compilations for broadcast on television.

16. The system of claim 1, wherein said website is able to make video and/or audio compilations in said storage device available for viewing to visitors of said website.

17. The system of claim 1, wherein website automatically sends a message to a user after a booking has been made informing said user at least approximately when and on what channel or channels the user's video and audio compilation is scheduled to be broadcast.

18. The system of claim 1, wherein said video compilations include thoughts, music videos, animations, opinions, short films, comments or remarks and audio compilations are inclusive of music albums, opinions, chats and discussions, and combinations thereof.

19. A interactive web-based network for playing video and/or audio compilations to television and/or radio channels on an outlet, said network comprising:
an accessible website for interacting with users that have created a video or audio compilation;
an web server for receiving communications from users at said website;
an interactive platform on said website for presenting options to a user for selecting:
available times to a user at which said video specified transmission on TV/Radio;
a location or locations where the user's video and/or audio compilations may be booked for play on one or more outlets;
a channel or channels within the location or locations selected; and
a storage device accessible by an operator of the website for making stored video and/or audio compilations available for later editing by a website operator and/or for transmitting said compilations to an operator of said outlet;
a portal for delivering said video and audio compilations to an operator of said outlet.

20. The network of claim 19, wherein the said server comprises:
a customized web site recognizing unit;
a sign up unit;
and,
a reporting unit.
